(19) United States
(12) Patent Application Publication
(10) Pub. No.: US 2002/0056317 A1
(43) Pub. Date: May 16, 2002

(54) Method and arrangement for measuring linting of fibrous materials

(75) Inventor: Mikael Strandqvist, Lindome (SE)

Correspondence Address: YOUNG & THOMPSON, 745 SOUTH 23RD STREET 2ND FLOOR, ARLINGTON, VA, 22202

(73) Assignee: SCA Hygiene Products AB

(21) Appl. No.: 09/987,598

(22) Filed: Nov. 15, 2001

Related U.S. Application Data
(60) Provisional application No. 60/248,566, filed on Nov. 16, 2000.

(51) Int. Cl. G01L 5/04

(52) U.S. Cl. 73/159

(57) ABSTRACT

A method of measuring Tinting of fibrous materials, includes:

h) fastening a sample of the material to a holder that is fixed to the end of an arm which is arranged to press the sample against a flat support surface with a specific force and moving the sample in a determined pattern on the planar support surface;

i) applying a specific amount of water onto the planar support surface at a specific place thereon;

j) moving the sample into abutment with the planar support surface at the place in which the water was applied;

k) causing the arm to press the sample against the support surface with a specific force and moving the sample in a specific pattern;

l) moving the sample away from the support surface;

m) removing water from the support surface and applying a device that functions to count the number of fibers present in the water; and

n) counting the number of fibers present in the water.

### FIELD OF INVENTION

The present invention relates to a method and to an arrangement for measuring linting of a fibrous material.

### DESCRIPTION OF THE BACKGROUND ART

Fibrous materials, for instance nonwoven fiber fabric, is often used industrially to wipe cleaning agents from surfaces whose cleanliness is decisive for the result of later treatment, for instance metal sheet to be lacquered or varnished, or printing plates in the graphic industry. When used for this purpose, the fibrous material must not release excessive fibers that lint or fuzz the dried surface. Consequently, there is a need of being able to measure linting of material that shall be offered to industry and other consumers. Although several methods are known for measuring linting of fibrous materials, none of these methods enable the measurements to be adapted to the use for which the material is intended, and consequently the linting values obtained do not constitute a safe measurement of linting in respect of the use for which the material is intended.

There is therefore a need of a flexible Tinting measuring method in which the conditions that prevail in the use for which a fibrous material is intended can be emulated so that the measurement values obtained will constitute a safe and reliable estimation of the suitability of the material in respect of a specific use.

It is the aim of the present invention to fulfil this requirement.

### SUMMARY OF THE INVENTION

a) This Aim is Fulfilled with a Method of Measuring Linting of a

This method enables the pattern of movement of the sample and the force at which the sample is pressed against the support surface to be adapted readily to the conditions that prevail in the use for which the fibrous material is intended, which means that the measurement values will be relevant to this use.

In one preferred embodiment, additional water is applied to the planar support surface after the sample has been moved away therefrom and prior to the water being removed from the planar support surface and passed to the fiber counting device. Further water may also be applied to the planar support surface after the water first applied has been passed to the fiber counting device, whereafter this additional water is removed from the planar support surface and passed to the fiber counting device. The arm used to move the sample is preferably a computer controlled robotic arm that can be programmed to press the sample against the support surface at a selected force within the range of 0-30 N and move the sample in a selected movement pattern. The robotic arm is beneficially programmed to collect a vessel for taking water from a water reservoir at a specific location, to move the vessel to a water reservoir from which the vessel is filled with a determined amount of water, to move the water-containing vessel to a specific place on the planar support surface, to pour water from the vessel onto said specific place, to move the empty vessel to a storage place, to-thereafter collect the vessel to which the sample is fastened, and to move the sample to the place on the planar support surface at which the water was applied.

In one variant of the invention, all method steps are carried out automatically.

The invention also relates to plant for measuring Tinting of a fibrous material, this plant being characterised in that it includes a holder for holding a sample of fibrous material, an arm that includes a free end which can be moved in a selected pattern of movement in space within the area of movement of said arm, and which is provided with a holder fastener, arm moving means, means for guiding arm movement, a planar plate situated within the movement area of the arm, means for pressing the arm against the planar plate with a specific force, means for applying water to the plate, means for removing water from said plate, and means for counting the number of fibers present in the water removed from the plate.

In one preferred embodiment of the invention, the holder is rotatable about an axis which is perpendicular to the plate when the sample is pressed against the plate, and the arm is comprised of the arm of a computer controlled robot. The plant may also include a water reservoir and means for filling a vessel with a specific volume of water from the reservoir, and then emptying the vessel at a specific place on the plate.

### BRIEF DESCRIPTION OF THE DRAWINGS

The invention will now be described in more detail with reference to the accompanying Figures, in which

FIG. 1 illustrates schematically Tinting measuring plant in accordance with a preferred embodiment of the invention; and

FIG. 2 is a schematic perspective view of a nonwoven sample holder included in the plant shown in FIG. 1.

### DESCRIPTION OF EMBODIMENTS

The illustrated linting measuring plant includes a robot 1 that comprises an arm 2 that carries on its end a gripping device 3 for a holder 4. The plant also includes a planar plate 5, a station 6 on which the sample holder 4 is positioned, a vessel 7 for containing de-ionised water, and a pipette 8 placed in a pipette holder 9. A fiber counter and a rubber scraper are also included in the plant.

The robot arm 2 is pivotal about a pivot joint 10 fastened to one end of a link arm 11, the other end of which is pivotally mounted about a pivot joint 12 attached to a generally U-shaped or stirrup-shaped element 13 which, in turn, is carried by a support 14 fixed to the. support surface. This construction enables the free end of the robot arm 2 to move freely in a vertical plane. The generally U-shaped element 13 is rotatable about a vertical axis, meaning that the end of the arm 2 is freely moveable in space.

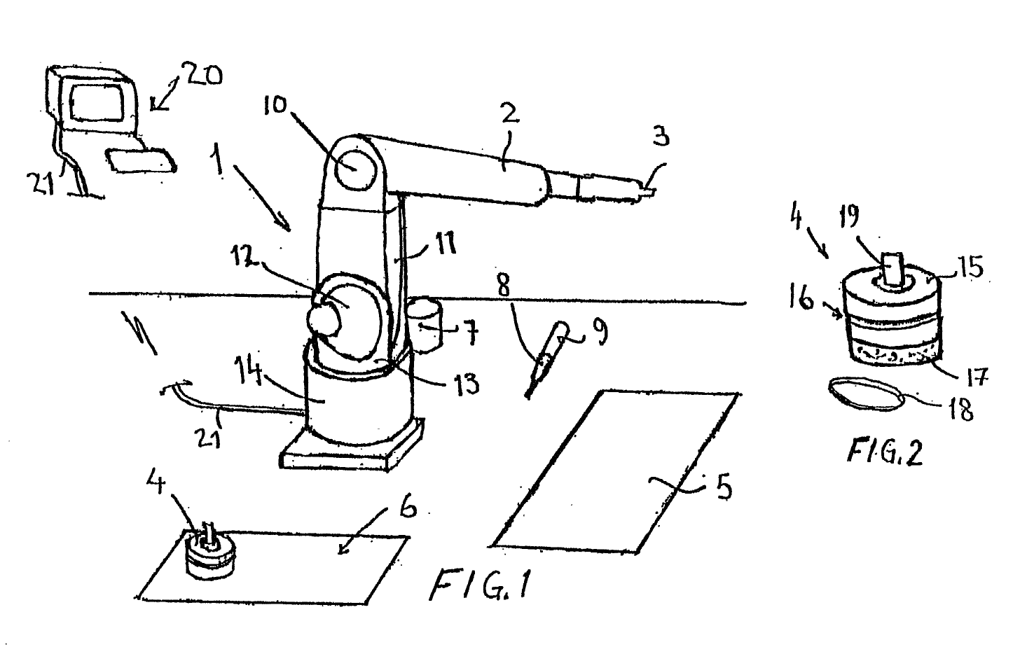

The robot 1 includes suitable means, e.g. electric motors, for achieving rotation of the robot arm and the link arm 11 around the respective horizontal pivot joints 10 and 12, and rotation of the generally U-shaped element 13 about a vertical axis. The robot is also connected to a computer 20 for controlling said rotational movements, by means of electric cables 21 as shown schematically in FIG. 1.

The robot arm 2 incorporates pressure sensors that detect the pressure load on the end of the arm.

Robots of the aforedescribed kind are available commercially and the construction of the robot constitutes no part of the present invention.

The robot 1 may, for instance, comprise a Robotcell 80706 from CRS Robotics, Nordics AB, Lund, Sweden, that includes a robot controller C500, robot arm A465, force sensor with box and switch, 32N 2.2 Nm, 65N (manufactured by Force Assurance Technologies Inc.) and gripping means SG 5796.

The pipette equipment used is also available commercially and may consist of pipette equipment designated EDOS 5222 from Eppendorf, Hamburg, Germany. This equipment enables setting of the amount of water that is to be taken up by the pipette and then delivered to the plate.

The fiber counter is comprised of a Kaajani FS 100 from Neles Automation, Karlstad, Sweden.

The sample holder 4 is shown schematically in FIG. 2 and includes a cylindrical body 15 that has a circumferentially extending groove 16 and a resilient plate 17, e.g. a plastic foam plate, at one end. The sample holder also includes a ring of elastic material that fits in the groove 16 and functions to hold a sample piece in the groove 16. The sample holder also includes a gripping part 19 that co-acts with the gripping device 3 on the robot arm 2. A sample holder including plastic foam of the type Bulpren R 60 with a diameter of 113 mm from Recticel, Brussels, Belgium, is suitable for use in the present context.

The plate 5 may comprise a glass plate measuring 300×500 mm and having edges of a height of 15 mm.

The plant operates in the following manner.

If the material has the same properties on both of its sides, five circular samples having a diameter of 19 cm are first punched from the material to be tested,. If the material has different properties on mutually opposite sides, ten samples are punched from said material. A sample is then mounted on the holder 4 and the holder then placed on the station 6 shown in FIG. 1, in the place illustrated in the Figure. A test program is then selected and loaded into the computer 20 belonging to the plant, whereafter measuring is commenced.

In the described embodiments, the measuring process is commenced by the gripping device 3 of the robot collecting the pipette 8 and moving the pipette to the vessel 7, from which a specific amount of de-ionised water is taken-up (e.g. 10 ml). The filled pipette 8 is then moved to a specific place immediately above the plate 5 and the water contained in the pipette poured onto the plate 5. The empty pipette is then returned to its holder 9.

The robot 1 then fetches the sample attached to the sample holder 4 and moves the sample to the place on the plate 5 at which the water was poured from the pipette 8. The sample is then pressed against the plate 5 at a set force and the end of the robot arm 2 is caused to move in a pattern determined by the test program. The end of the robot arm 2 is pivotally mounted in a manner such that the underside of the holder 4 will be constantly held horizontal. The gripping device is also rotatably carried in the arm 2 in a manner to enable the sample to rotate around an axis that is perpendicular to the plane of the plate 5.

Upon completion of the test program, the robot 1 moves the sample to the setup station 6 and returns to its starting position.

The water on the plate 5 is then scraped manually into a beaker with the aid of a rubber scraper. In order to ensure that all fibers linted by the sample have been collected, it may be suitable, although not necessary, to apply more water to the plate prior to the scraping process, e.g. about 50 ml. This procedure can be repeated two or more times, in order to be completely sure that no fibers remain on the plate.

The water contained in the beaker is then passed to a fiber counter, which counts the number of fibers present in the water.

The tested sample is then removed from the holder 4 and the described procedure repeated with fresh samples until all of the samples punched from said material have been tested.

In one variant (not shown), the plate 5 is provided with a closable drain that leads to the fiber counter, and the plant includes an automatic scraping device. In the case of this variant, the computer is programmed to carry out the measuring process fully automatically.

The computer will conveniently include a number of different standard test programmes in which various, conventional movement schemes for the different usages of fibrous material are emulated. The computer will also conveniently include a program for selectively combining a number of standard movements to form a selected movement scheme for the sample.

It will be understood that several modifications to the described embodiment are possible within the scope of the invention. For instance, there can be used other types of robots that permit the end of a robot arm to move freely in space. It is also possible to use a steel plate instead of a glass plate, or a plate comprised of the same material as that with which the tested fibrous material is intended to be used. Moreover, devices other than pipette equipment can be used to deliver a specific amount of water to the plate, e.g. a beaker or like device and a beaker filling means. It will therefore be understood that the invention is limited solely by the contents of the accompanying Claims.

1. A method of measuring linting of fibrous materials, characterised by a
fastening a sample of the material to a holder that is fixed to the end of an arm which is arranged to press the sample against a flat support surface with a specific force and moving the sample in a determined pattern on the planar support surface;
b) applying a specific amount of water onto the planar support surface at a specific place thereon;
c) moving the sample into abutment with the planar support surface at the place in which the water was applied;
d) causing the arm to press the sample against the support surface with a specific force and moving the sample in a specific pattern;
e) moving the sample away from the support surface;
f) removing water from the support surface and applying a device that functions to count the number of fibers present in the water; and
g) counting the number of fibers present in the water.

2. A method according to claim 1, characterised by applying further water to the planar support surface after having moved the sample away therefrom and prior to removing water from the planar support surface and passing said water to the fiber counter.

3. A method according to claim 1 or 2, characterised by applying further water to the planar support surface after the water first applied has been delivered to the fiber counter, whereafter said further water is removed from the planar support surface and delivered to the fiber counter.

4. A method according to claim 1, 2 or 3, characterised in that the arm used to move the sample is comprised of a computer controlled robot arm which can be programmed to press the sample against the support surface at a selective force within the range 0-30 N, and to move the sample in a selected movement pattern.

5. A method according to claim 4, characterised by programming the robot arm to fetch a vessel for taking water from a water reservoir in a specific location, moving the vessel to a water reservoir and filling the vessel with a specific amount of water, moving the filled vessel to a specific place on the planar support surface, emptying the water in the vessel onto said specific place, moving the empty vessel to a storage facility, thereafter fetching the holder to which the sample is attached, and moving the sample to the place on the planar support surface in which the water was applied.

6. A method according to any one of claims 1-5, characterized by performing all method steps automatically.

7. Plant for measuring Tinting of a fibrous material, characterized in that the plant includes a holder (4) for holding a sample of the fibrous material, an arm (2) that has a free end which can be moved in a selected movement pattern in space within the area of movement of said arm, and which includes a holder attachment (3), means for moving the arm, means for controlling arm movement, a planar plate (5) situated within the area of arm movement, means for pressing the end of the arm (2) against the planar plate at a specific force, means for applying water to the plate (8), means for removing water from the plate, and means for counting the number of fibers present in the water removed from the plate.

8. Plant according to claim 7, characterised in that the holder (4) is rotatable about an axis that is perpendicular to the plate (5) when the sample is pressed against said plate.

9. Plant according to claim 8, characterised in that the arm (2) is the arm of a computer controlled robot (1).

10. Plant according to claim 7, 8 or 9,, characterised in that the plant includes a water reservoir and means for filling a vessel (8) with a specific amount of water from the reservoir and then emptying the vessel onto a specific place on the plate (5).
